(19) United States
(12) Patent Application Publication
(10) Pub. No.: US 2026/0222799 A1
(43) Pub. Date: Jul. 30, 2026

(54) DEVICE IDENTIFICATION METHOD AND SYSTEM, AND STORAGE MEDIUM

(71) Applicant: Advanced Nova Technologies (Singapore) Holding Pte. Ltd., Singapore (SG)

(72) Inventors: Jiaming ZHU, Hangzhou (CN); Xiao TAN, Hangzhou (CN); Shuai CHEN, Hangzhou (CN)

(21) Appl. No.: 19/417,061

(22) Filed: Dec. 11, 2025

(30) Foreign Application Priority Data
Jan. 24, 2025 (SG) 10202500229R

(51) Int. Cl. H04W 8/24

(52) U.S. Cl. CPC H04W 8/24

(57) ABSTRACT

This specification provides a device identification method and system, and a storage medium. In the method, a server obtains first device information corresponding to a target terminal device and N pieces of second device information associated with a target user, where the second device information is device information of a historical terminal device previously used by the target user, and N is an integer greater than or equal to 1; and then the server separately determines a transition probability between each of the N pieces of second device information and the first device information; and identifies, based on the transition probability, whether the target terminal device is the historical terminal device previously used by the target user.

### TECHNICAL FIELD

This specification relates to the field of Internet technologies, and in particular, to a device identification method and system, and a storage medium.

### BACKGROUND

When a user initiates a service request with a relatively high security requirement to a service platform, for example, when the user initiates a payment request or a login request, the service platform usually triggers identity verification on the user, to check whether the user is a valid user. Only when the identity verification succeeds, a corresponding service is provided to a target user.

In some cases, when receiving, from a terminal device, a service request sent by a user, the server can determine whether the current terminal device is a historical terminal device previously used by the user, and does not need to perform identity verification on the current user when a determining result is yes. In this way, relatively much disturbance to the user can be avoided. However, how to accurately identify whether the current terminal device is the historical terminal device previously used by the user is a technical problem that needs to be resolved.

Content in the background is merely information known to the inventor, and neither means that the information has entered the public domain before the application date of this disclosure, nor means that the information can become the existing technology of this disclosure.

### SUMMARY

This specification provides a device identification method and system, and a storage medium. When it is identified whether a target terminal device is a historical terminal device previously used by a target user, a transformation possibility of device information of the terminal device is considered, so that an identification result is more accurate.

According to a first aspect, this specification provides a device identification method, including: obtaining first device information corresponding to a target terminal device, and obtaining N pieces of second device information associated with a target user, where the second device information is device information of a historical terminal device previously used by the target user, and N is an integer greater than or equal to 1; determining a transition probability between each of the N pieces of second device information and the first device information, where the transition probability represents a possibility that device information of a same terminal device is transformed from the second device information to the first device information; and identifying, based on the transition probability between each of the N pieces of second device information and the first device information, whether the target terminal device is the historical terminal device previously used by the target user.

According to a second aspect, this specification further provides a device identification system, including at least one storage medium and at least one processor. The at least one storage medium stores at least one instruction set for performing device identification. The at least one processor is communicatively connected to the at least one storage medium. When the device identification system runs, the at least one processor reads the at least one instruction set, and performs the following operations based on an indication of the at least one instruction set: obtaining first device information corresponding to a target terminal device, and obtaining N pieces of second device information associated with a target user, where the second device information is device information of a historical terminal device previously used by the target user, and N is an integer greater than or equal to 1; determining a transition probability between each of the N pieces of second device information and the first device information, where the transition probability represents a possibility that device information of a same terminal device is transformed from the second device information to the first device information; and identifying, based on the transition probability between each of the N pieces of second device information and the first device information, whether the target terminal device is the historical terminal device previously used by the target user.

According to a third aspect, this specification further provides a non-transitory computer-readable storage medium. The non-transitory computer-readable storage medium stores at least one instruction set, and when the at least one instruction set is executed by at least one processor, the method according to any implementation of the first aspect is implemented.

Other functions of the device identification method and system, and the storage medium provided in this specification are partially listed in the following descriptions. Creative aspects of the device identification method and system, and the storage medium provided in this specification can be fully explained by practice or by using the methods, apparatuses, and combinations described in the following detailed examples.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description show merely some embodiments of this specification, and a person of ordinary skill in the art can still derive other drawings from these accompanying drawings without creative efforts.

FIG. 1 is a schematic diagram of an application scenario according to an embodiment of this specification;

FIG. 2 is a schematic diagram of hardware of a computing device according to an embodiment of this specification;

FIG. 3 is a flowchart of a device identification method according to an embodiment of this specification;

FIG. 4 is a schematic diagram of a manner of determining a transition probability according to an embodiment of this specification; and

FIG. 5 is a schematic diagram of another manner of determining a transition probability according to an embodiment of this specification.

### DESCRIPTION OF EMBODIMENTS

Specific application scenarios and requirements of this specification are provided in the following descriptions, so that a person skilled in the art can manufacture and use content of this specification. Various local modifications to the disclosed embodiments are clear to a person skilled in the art. In addition, the general principles defined herein can be applied to other embodiments and applications without departing from the spirit and scope of this specification. Therefore, this specification is not limited to the shown embodiments, but has a widest scope consistent with that of the claims.

The terms used herein are merely intended to describe specific example embodiments, and impose no limitation. For example, unless otherwise explicitly stated in the context, the singular forms “one”, “an”, and “the” used herein can include plural forms. When being used in this specification, the terms “include”, “comprise”, and/or “have” mean existence of an associated integer, step, operation, element, and/or component, but does not preclude existence of one or more other features, integers, steps, operations, elements, components, and/or groups or addition of other features, integers, steps, operations, elements, components, and/or groups to the system/method.

In consideration of the following descriptions, these and other features of this specification, operations and functions of related components of the structure, and economy of combination and manufacturing of components can be significantly improved. With reference to the accompanying drawings, all of these form a part of this specification. However, it should be clearly understood that the accompanying drawings are merely used for the purpose of illustration and description, and are not intended to limit the scope of this specification. It should be further understood that the accompanying drawings are not drawn to scale.

The flowchart used in this specification shows operations implemented by a system according to some embodiments of this specification. It should be clearly understood that the operations in the flowchart may not be sequentially implemented. On the contrary, the operations can be implemented in a reverse order or simultaneously. In addition, one or more other operations can be added to the flowchart, and one or more operations can be removed from the flowchart.

Before specific embodiments of this specification are described, an application scenario to which the technical solutions provided in this specification are applicable is first described.

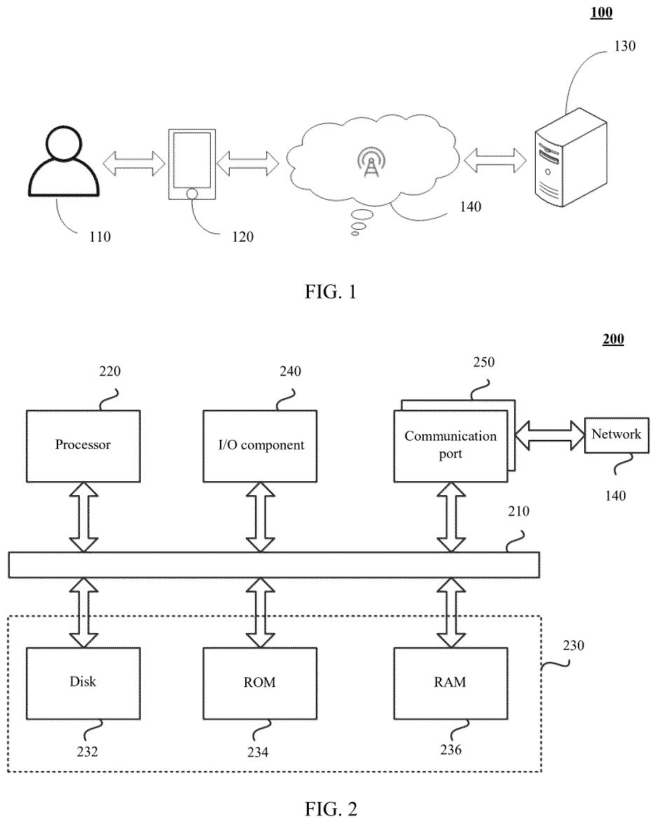

FIG. 1 is a schematic diagram of an application scenario according to an embodiment of this specification. As shown in FIG. 1, the application scenario 100 can include a user 110, a terminal device 120, a server 130, and a network 140.

The user 110 can initiate a service request on the terminal device. For example, the terminal device 120 can present an interaction interface to the user, so that the user 110 can initiate the service request through the interaction interface. For example, the service request can be a payment request or a login request.

In some embodiments, the terminal device 120 can include a mobile device, a tablet computer, a notebook computer, a built-in device in a motor vehicle or similar content, or any combination thereof. In some embodiments, the mobile device can include a smart home device, a smart mobile device, a virtual reality device, an augmented reality device or a similar device, or any combination thereof. In some embodiments, the smart home apparatus can include a smart television, a desktop computer, or any combination. In some embodiments, the smart mobile device can include a smartphone, a personal digital assistant, a game device, a navigation device, or any combination thereof. In some embodiments, the virtual reality device or the augmented reality device may include a virtual reality helmet, virtual reality glasses, a virtual reality patch, an augmented reality helmet, augmented reality glasses, an augmented reality patch or similar content, or any combination thereof. For example, the virtual reality device or the augmented reality device may include Google glasses, a head mounted display, or VR. In some embodiments, the built-in apparatus in the motor vehicle can include a vehicle-mounted computer, a vehicle-mounted television, or the like. In some embodiments, the terminal device 120 can include an image capture device, configured to collect user data of the user 110. In some embodiments, the image capture device can be a two-dimensional image capture device (for example, an RGB camera), or can be a device that combines both two-dimensional image capture (for example, an RGB camera) and depth image capture (for example, a 3D structured light camera or a laser detector). In some embodiments, the terminal device 120 can be a device with a location technology, configured to locate the terminal device 120.

The server 130 can be a server that provides various services. For example, the server 130 can be a server that provides a payment service or a login service to the terminal device 120. Referring to FIG. 1, the terminal device 120 is communicatively connected to the server 130. The terminal device 120 can send a service request to the server 130. In response to the service request, the server 130 can provide a corresponding service to the terminal device 120.

In some scenarios, when the user 110 initiates a service request, the terminal device 120 or the server 130 usually needs to perform identity verification on the user 110. An objective of the identity verification is to verify whether the user 110 is a registered user/valid user. A manner for the identity verification includes but is not limited to entering an account password, entering an SMS verification code, face comparison, fingerprint comparison, and the like. Only when the identity verification succeeds, the server 130 provides a corresponding service to the user 110. However, if the server 130 performs identity verification on the user 110 each time the user 110 requests a service, relatively much disturbance is caused to the user 110, degrading service experience of the user.

In some embodiments, to avoid causing relatively much disturbance to the user 110, when receiving, from the terminal device 120, a service request triggered by the user 110, the server 130 can determine whether the current terminal device is a historical terminal device previously used by the user 110. If yes, the server 130 considers that security of this service request is relatively high, and does not need to perform identity verification on the user 110. If no, the server 130 considers that security of this service request is relatively low, and needs to perform identity verification on the user 110.

In some embodiments, the server 130 can perform device identification in a device fingerprint-based manner. Specifically, when receiving, from the terminal device 120, the service request triggered by the user 110, the server 130 can obtain a large quantity of device parameters of the terminal device 120, and generate, based on the large quantity of device parameters, a feature that can uniquely identify the terminal device 120. The feature can be referred to as a device fingerprint. The server 130 can store a correspondence between the user 110 and the device fingerprint. Subsequently, when receiving, from a terminal device, a service request triggered by the user 110, the server 130 can obtain a large quantity of device parameters of the current terminal device, and generate a current device fingerprint based on the large quantity of device parameters. Further, the server 130 compares the current device fingerprint with a historical device fingerprint corresponding to the user 110, and determines, based on a comparison status, whether the current terminal device is a historical terminal device previously used by the user 110.

In the above-mentioned manner, to enable the generated device fingerprint to uniquely represent the terminal device, the server 130 needs to obtain an excessively large quantity of device parameters of the terminal device, for example, obtain parameters of the terminal device in a plurality of dimensions such as hardware, software, a configuration, a network environment, and historical behavior of the user on the terminal device. For example, device parameters in the software dimension can include but are not limited to an operating system type and version, a browser type and version, an installed application program and a version, and the like. For example, device parameters in the hardware dimension can include but are not limited to a device model, a processor type, a memory size, a hard disk serial number, screen resolution, a media access control (MAC) address, an international mobile equipment identity (IMEI), an international mobile subscriber identity (IMSI), a network standard, a baseband number, and the like. For example, device parameters in the network environment dimension can include but are not limited to an IP address, an operator name, Wi-Fi network information, cellular network information, and the like. For example, device parameters in historical behavior dimension include but are not limited to a browsing history, a touchscreen use mode, a typing speed, and the like. In addition, the device parameters obtained by the server can further include other parameters such as a device serial number, a power-on time, a user-defined device name, and the like. Details are not described herein again.

However, a complex collection procedure is required to collect enough device parameters. When processing the large quantity of device parameters to generate a device fingerprint, the server 130 needs to consume a large quantity of computing resources. In addition, the server 130 needs to store a large quantity of device parameters collected each time and a device fingerprint corresponding to the large quantity of device parameters, resulting in data storage pressure. In addition, as time goes by, the device parameters corresponding to the terminal device undergo some changes, for example, an operating system upgrade, a browser version update, and a change in a network service provider. The device fingerprint may change due to these changes. Therefore, a case of incorrect determining may occur when the server 130 identifies, based on the device fingerprint, whether the current terminal device is the historical terminal device. For example, the current terminal device used by the user to trigger the service request this time and the historical terminal device previously used by the user to trigger a service request are a same terminal device. However, because some device parameters of the terminal device change within a time interval between the two service requests, two generated device fingerprints are different, and a service platform incorrectly determines that the current terminal device is not the historical terminal device.

Therefore, this specification provides a device identification method. The method can be performed by the server 130 in FIG. 1. When identifying whether a current terminal device is a historical terminal device, the server 130 no longer depends on a result of comparison between device fingerprints, but considers a transformation possibility of device information of a same terminal device. Specifically, after obtaining first device information corresponding to the current terminal device, the server 130 determines, based on a transition probability between second device information corresponding to the historical terminal device previously used by a target user and the first device information, whether the current terminal device is the historical terminal device. In the above-mentioned solution, the transformation possibility of the device information of the same terminal device is considered. This is more consistent with an actual use status of the terminal device, and therefore a device identification result is more accurate.

Further, in a service request scenario, when identifying that the current terminal device is the historical terminal device, the server 130 directly provides a corresponding service to the user by skipping an identity verification procedure. This can reduce a quantity of times the user is disturbed by the identity verification procedure, reduce concerns of the user about personal privacy, and improve service experience of the user. When identifying that the current terminal device is not the historical terminal device, the server 130 provides a corresponding service after performing identity verification on the user, thereby ensuring service security.

The server 130 can store data or instructions for performing the device identification method described in this specification, and can execute or be configured to execute the data or the instructions. In some embodiments, the server 130 can include a hardware device with a data information processing function and a program needed to drive the hardware device to work.

Still referring to FIG. 1, the network 140 is configured to provide a medium for communication connection between the terminal device 120 and the server 130. The network 140 can facilitate exchange of information or data. In some embodiments, the network 140 can be any type of wired or wireless network, or a combination thereof. For example, the network 140 can include a cable network, a wired network, an optical fiber network, a telecommunications network, an intranet, the Internet, a local area network (LAN), a wide area network (WAN), a wireless local area network (WLAN), a metropolitan area network (MAN), a public switched telephone network (PSTN), a Bluetooth network, a ZigBee network, a near field communication (NFC) network, or a similar network. In some embodiments, the network 140 can include one or more network access points. For example, the network 140 can include a wired or wireless network access point, for example, a base station or an Internet switching point. Through the access point, one or more components of the terminal device 120 and the server 130 can be connected to the network 140 to exchange data or information.

It should be understood that quantities of terminal devices 120, servers 130, and networks 140 in FIG. 1 are merely examples. Based on an implementation requirement, there can be any quantity of terminal devices 120, servers 130, and networks 140.

It should be noted that when an example is involved in this specification, a payment scenario and a login scenario are used as examples for description. In addition to the payment scenario and the login scenario, the device identification method provided in this specification can be further applied to another similar scenario. A person skilled in the art can understand that a specific implementation and technical effects of application to another scenario are similar. Details are not described again in this specification.

FIG. 2 is a schematic diagram of hardware of a computing device 200 according to an embodiment of this specification; The computing device 200 can serve as the server 130 in FIG. 1. The computing device 200 can perform the device identification method provided in this specification. The device identification system provided in this specification can have the hardware structure shown in FIG. 2. That is, the computing device 200 shown in FIG. 2 can also be referred to as a device identification system.

As shown in FIG. 2, the computing device 200 can include at least one storage medium 230 and at least one processor 220. In some embodiments, the computing device 200 can further include a communication port 250 and an internal communication bus 210. The computing device 200 can further include an I/O component 240.

The internal communication bus 210 can be connected to different system components, including the storage medium 230, the processor 220, and the communication port 250.

The I/O component 240 supports input/output between the computing device 200 and other components.

The communication port 250 is used for data communication between the computing device 200 and the outside. For example, the communication port 250 can be used for data communication between the computing device 200 and the network 140. The communication port 250 can be a wired communication port, or can be a wireless communication port.

The storage medium 230 can include a data storage apparatus. The data storage apparatus can be a non-transitory storage medium, or can be a transitory storage medium. For example, the data storage apparatus can include one or more of a disk 232, a read-only storage medium (ROM) 234, or a random access storage medium (RAM) 236. The storage medium 230 further includes at least one instruction set stored in the data storage apparatus. The instruction set can be computer program code, and the computer program code can include a program, a routine, an object, a component, a data structure, a process, a module, and the like for performing the method provided in this specification.

The processor 220 is communicatively connected to the storage medium 230. The processor 220 is configured to execute the at least one instruction set. When the computing device 200 runs, the processor 220 reads the at least one instruction set, and performs, based on an indication of the at least one instruction set, the device identification method provided in this specification. The processor 220 can perform all steps included in the device identification method. The processor 220 can be in a form of one or more processors. In some embodiments, the processor 220 can include one or more hardware processors, for example, a microcontroller, a microprocessor, a reduced instruction set computer (RISC), an application-specific integrated circuit (ASIC), an application-specific instruction set processor (ASIP), a central processing unit (CPU), a graphics processing unit (GPU), a physical processing unit (PPU), a microcontroller unit, a digital signal processor (DSP), a field programmable gate array (FPGA), an advanced RISC machine (ARM), a programmable logic device (PLD), any circuit, processor, or the like that can perform one or more functions, or any combination thereof.

To merely describe a problem, FIG. 2 shows only a case in which the computing device 200 includes one processor 220. However, it should be noted that the computing device 200 in this specification can further include a plurality of processors 220. Therefore, the operations and/or method steps disclosed in this specification can be performed by one processor, or can be jointly performed by a plurality of processors. For example, if the processor 220 in the computing device 200 in this specification performs step A and step B, it should be understood as that step A and step B can be jointly or separately performed by two different processors 220 (for example, a first processor performs step A, and a second processor performs step B, or a first processor and a second processor jointly perform steps A and B).

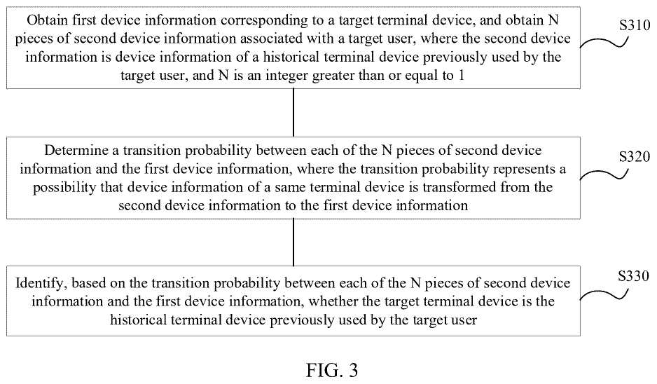

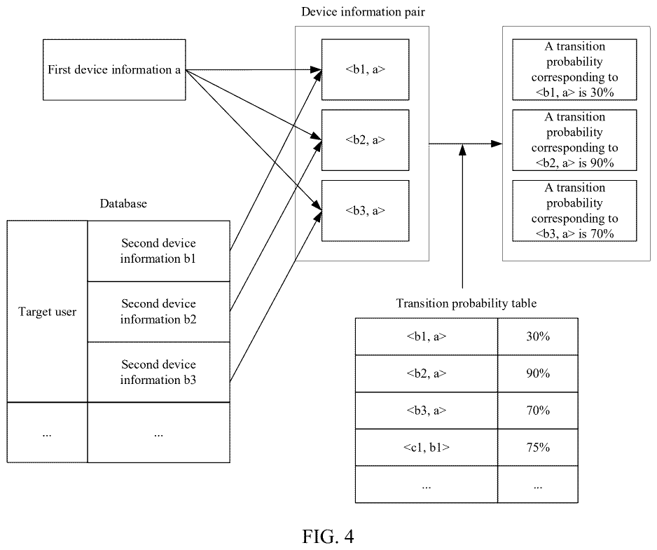

FIG. 3 is a flowchart of a device identification method P300 according to an embodiment of this specification. The server 130 can perform the device identification method P300. Specifically, a processor in the server 130 can read an instruction set stored in a local storage medium of the server 130, and then perform the device identification method P300 based on a stipulation of the instruction set.

As shown in FIG. 3, the device identification method P300 can include steps S310 to S330.

S310: Obtain first device information corresponding to a target terminal device, and obtain N pieces of second device information associated with a target user, where the second device information is device information of a historical terminal device previously used by the target user, and N is an integer greater than or equal to 1.

The target terminal device can be a current to-be-identified terminal device. The target terminal device can also be referred to as a current terminal device. The historical terminal device is a terminal device previously used by the target user, that is, a terminal device used by the target user in a historical time period. There may be one or more historical terminal devices previously used by the target user.

In some embodiments, the target terminal device can be a terminal device that currently requests a service from the server 130. For example, the server 130 receives a service request from the target terminal device. The service request represents that the target user requests a service (for example, a payment service or a login service). In this case, the server 130 can identify, by performing the device identification method P300 provided in this specification, whether the target terminal device is the historical terminal device previously used by the target user. The service request can be a payment request, a login request, or the like.

In this specification, the device information is related information used to describe an attribute of a terminal device. For ease of description and distinction, in this specification, device information corresponding to the target terminal device is referred to as the first device information, and device information corresponding to the historical terminal device is referred to as the second device information. The server 130 can store the N pieces of second device information corresponding to the target user.

The first device information includes K information items. In some embodiments, the K information items are used to describe an intrinsic attribute of the target terminal device. In some embodiments, the K information items are used to describe a weakly variable attribute of the target terminal device. In some embodiments, the K information items are used to describe an intrinsic attribute and a weakly variable attribute of the target terminal device.

The intrinsic attribute can be understood as an attribute that does not change in a use process of the terminal device, for example, a device model, a device development board model, and processor information. The attribute is determined by hardware of the terminal device. When the hardware of the terminal device remains unchanged, the attribute information of the terminal device does not change.

The weakly variable attribute information can be understood as an attribute that may change in a use process of the terminal device but has a relatively low possibility of change or a relatively low degree of change, for example, operating system information, a memory capacity, an operator type, and screen resolution. For example, the screen resolution is used as an example. In the use process of the terminal device, a screen of the terminal device does not undergo hardware changes. Therefore, in principle, the screen resolution of the terminal device does not change. However, there may be a data collection error during device information collection, and therefore there is a slight difference between screen resolution collected at two times. Therefore, the screen resolution is a weakly variable attribute of the terminal device. For another example, the operator type is used as an example. In the use process of the terminal device, when the user does not actively change an operator, the operator type of the terminal device does not change, and only when the user actively changes the operator, the operator type of the terminal device changes. In actual application, the user usually does not frequently replace the operator. Therefore, there is a relatively low possibility that the operator type changes, and the operator type is a weakly variable attribute of the terminal device.

In the technical solution in the above-mentioned embodiment, the first device information basically does not change in a process of using the terminal device by the user, is relatively stable, and does not involve user privacy. Therefore, in the above-mentioned solution, device identification is performed by using the first device information, to reduce or eliminate impact of a variable factor, reduce incorrect determining caused by a change of a device fingerprint, and improve accuracy of a device result.

In some embodiments, the K information items in the first device information include at least one of a device model, operating system information, processor information, a memory capacity, a device development board model, an operator type, and screen resolution. The operating system information can include at least one of an operating system type and an operating system version. The processor information can include at least one of a quantity of cores of a processor, a processor frequency, and a processor manufacturer.

In the technical solution in the above-mentioned embodiment, the first device information includes a relatively small quantity of information items. Therefore, the terminal device needs to collect only a relatively small quantity of information items, and does not need to perform a complex collection and processing procedure, thereby reducing consumption of computing resources and reducing data storage and processing pressure. In addition, in the above-mentioned solution, a probability that the device information changes due to a change in a use environment and configuration of the terminal device (for example, an operating system upgrade, a browser version update, or a network service provider change) and consequently incorrect determining is caused can be reduced.

A person skilled in the art can understand that the second device information includes a same information item as the first device information. For related content of the second device information, refer to the above-mentioned detailed descriptions of the first device information. Details are not described herein again.

There can be many manners in which the server 130 obtains the first device information. The following uses three manners as examples for description.

Manner 1: When the target terminal device detects that the user performs an operation (for example, performs a payment operation) for triggering a service request, the target terminal device collects the device information (that is, the first device information) of the target terminal device. Further, the target terminal device sends a service request to the server 130, and carries the first device information in the service request. In this case, after receiving the service request, the server 130 can parse the service request to obtain the first device information corresponding to the target terminal device.

Manner 2: When the target terminal device detects that the user performs an operation (for example, performs a payment operation) used to trigger a service request, the target terminal device sends a service request to the server 130. After the server 130 receives the service request, the server 130 sends indication information to the target terminal device, to indicate the target terminal device to collect the first device information of the target terminal device. The target terminal device collects the first device information of the target terminal device based on the indication information, and reports the first device information to the server 130.

Manner 3: When the target terminal device detects that the user performs an operation (for example, performs a payment operation) for triggering a service request, the target terminal device sends a service request to the server 130. Further, the target terminal device collects the first device information of the target terminal device, and reports the first device information to the server 130.

In some embodiments, a database used to store the second device information can be deployed on a side of the server 130. The database stores one or more pieces of second device information corresponding to each of different users. After receiving the service request initiated by the target user, the server 130 can obtain the N pieces of second device information corresponding to the target user from the database.

For example, Table 1 shows an example of a database. As shown in Table 1, the database includes one or more pieces of second device information corresponding to each of different users. For example, a user 1 corresponds to second device information b1, second device information b2, and second device information b3; and a user 2 corresponds to second device information c1, second device information c2, and second device information c3. Second device information corresponding to another user is obtained by analogy.

TABLE 1

| User | Device information |
|---|---|
| User 1 | Second device information b1 |
| | Second device information b2 |
| | Second device information b3 |
| User 2 | Second device information c1 |
| | Second device information c2 |
| | Second device information c3 |
| . . . | . . . |

S320: Determine a transition probability between each of the N pieces of second device information and the first device information, where the transition probability represents a possibility that device information of a same terminal device is transformed from the second device information to the first device information.

As described above, in the use process of the terminal device, the device information of the terminal device may change. In this specification, “a transformation possibility between two different pieces of device information corresponding to the terminal device” is referred to as a transition probability between the two pieces of device information. For example, “the possibility that the device information of the terminal device is transformed from the second device information to the first device information” is referred to as “the transition probability between the second device information and the first device information”.

After obtaining the first device information and the N pieces of second device information, the server 130 can separately determine the transition probability between each of the N pieces of second device information and the first device information.

The server 130 can determine the transition probability between each of the N pieces of second device information and the first device information in a plurality of manners. The following uses two manners as examples for description.

Manner 1: The transition probability between each of the N pieces of second device information and the first device information is determined by querying a transition probability table.

Specifically, a transition probability table can be deployed on the server 130, and the transition probability table can be pre-constructed. The transition probability table can represent a transition probability between different device information.

For example, Table 2 shows an example of a transition probability table. As shown in Table 2, the transition probability table includes a plurality of device information pairs and a transition probability corresponding to each device information pair. For example, if a transition probability corresponding to <device information b1, device information a> is 30%, it indicates that a transition probability for transformation from the device information b1 to the device information a is 30%; and if a transition probability corresponding to <device information b2, device information a> is 90%, it indicates that a transition probability for transformation from the device information b2 to the device information a is 90%. A meaning of a transition probability of another information pair is obtained by analogy.

TABLE 2

| | Transition |
|---|---|
| Device information pair | probability P |
| <device information b1, device information a> | 30% |
| <device information b2, device information a> | 90% |
| . . . | . . . |

It should be noted that in this specification, two pieces of device information in one device information pair are in an order. That is, <device information x, device information y> and <device information y, device information x> are different device information pairs, and meanings of transition probabilities corresponding to the two device information pairs are different. The transition probability corresponding to <device information x, device information y> represents a possibility that the device information of the same terminal device is transformed from the device information x to the device information y, and the transition probability corresponding to <device information y, device information x> represents a possibility that the device information of the same terminal device is transformed from the device information y to the device information x.

Based on the transition probability table, the server 130 can determine the transition probability between each of the N pieces of second device information and the first device information in the following manner: for each of the N pieces of second device information, querying the transition probability table based on the second device information and the first device information, to obtain the transition probability between the second device information and the first device information.

For ease of understanding, how the server 130 determines the transition probability between each of the N pieces of second device information and the first device information based on the transition probability table is described below in detail with reference to FIG. 4.

FIG. 4 is a schematic diagram of a manner of determining a transition probability according to an embodiment of this specification. It is assumed that the device information corresponding to the target terminal device is first device information a. Therefore, the server 130 obtains the first device information a. It is assumed that three pieces of second device information (that is, N=3) corresponding to the target user are stored in the database, and are denoted as second device information b1, second device information b2, and second device information b3.

After obtaining the first device information a and the three pieces of second device information b1, b2, and b3, the server 130 can combine the three pieces of second device information b1, b2, and b3 with the first device information a, to form three device information pairs. For example, the three device information pairs are <b1, a>, <b2, a>, and <b3, a>.

The server 130 stores the transition probability table. The server 130 can query the transition probability table, to obtain a transition probability corresponding to each device information pair. For example, for the device information pair <b1, a>, the server 130 can query the transition probability table based on the device information pair <b1, a>, to obtain a transition probability corresponding to the device information pair <b1, a>, so as to obtain a transition probability between the second device information b1 and the first device information a. For the device information pair <b2, a>, the server 130 can query the transition probability table based on the device information pair <b2, a>, to obtain a transition probability corresponding to the device information pair <b2, a>, so as to obtain a transition probability between the second device information b2 and the first device information a. For the device information pair <b3, a>, the server 130 can query the transition probability table based on the device information pair <b3, a>, to obtain a transition probability corresponding to the device information pair <b3, a>, so as to obtain a transition probability between the second device information b3 and the first device information a.

In the technical solution in the above-mentioned embodiment, the transition probability table indicates a transition probability between different device information. Therefore, the server 130 can obtain the transition probability between each of the N pieces of second device information and the first device information by querying the transition probability table. In this way, the manner of obtaining the transition probability is relatively simple and intuitive, and no complex calculation and assumption are required. In addition, because content in the transition probability table can be continuously accumulated, the content in the transition probability table are increasingly comprehensive. Therefore, transition probability query requirements of more scenarios can be met.

The following describes a construction process of the transition probability table. It should be noted that the construction process of the transition probability table can be performed by the server 130, or can be performed by another device. This is not limited in this specification. In the following descriptions, the server 130 is used as an example for description.

When the transition probability table is constructed, the server 130 can obtain device collection data of a plurality of users. The device collection data of each user includes a plurality of pieces of device information obtained by performing a plurality of times of information collection on a terminal device of the user. For example, the plurality of times of information collection can be performed based on a specific time interval, or can be performed when the terminal device initiates a service request. In some embodiments, device information obtained by performing information collection on the terminal device of each user can be stored in a database. Therefore, the database can store a plurality of pieces of device information corresponding to each of the plurality of users. In this way, the server 130 can obtain the plurality of pieces of device information corresponding to each of the plurality of users from the database, that is, obtain the device collection data of the plurality of users.

After obtaining the device collection data of the plurality of users, the server 130 can combine different device information in the device collection data of the plurality of users to generate a plurality of device information pairs. Each device information pair includes two pieces of device information arranged in an order.

For example, if the device collection data of the plurality of users includes device information 1, device information 2, and device information 3, different device information can be combined to form six device information pairs: <device information 1, device information 2>, <device information 1, device information 3>, <device information 2, device information 1>, <device information 2, device information 3>, <device information 3, device information 1>, and <device information 3, device information 2>. It should be noted that the device information pairs are arranged in an order, that is, <device information 1, device information 2> and <device information 2, device information 1> are different.

For each of the plurality of device information pairs, each device information pair includes two pieces of device information. For each device information pair, the server 130 can determine a transition probability between the two pieces of device information in each device information pair based on distribution of the two pieces of device information in the device information pair in the device collection data of the plurality of users.

In the technical solution in the above-mentioned embodiment, the server 130 determines a transition probability between two pieces of device information in one device information pair based on distribution of the two pieces of device information in the device collection data of the plurality of users, so that the determined transition probability conforms to a statistical rule, to ensure accuracy of the transition probability.

In some embodiments, the distribution can be represented by a ratio of users that meet a target condition in the plurality of users. The target condition includes that the device collection data includes the two pieces of device information in the device information pair, and an order of the two pieces of device information in the device collection data is the same as an order of the two pieces of device information in the device information pair.

In an example of <device information 1, device information 2>, the target condition can be expressed as follows: Device information collected for an i^{th} time in the device collection data is the device information 1, and device information collected for an (i+1)^{th} time is the device information 2. A value of i can be an integer greater than or equal to 1. The target condition can alternatively be expressed that there is transformation from the device information 1 to the device information 2 in the device collection data.

Specifically, for each device information pair, the server 130 can determine a quantity of users that meet the target condition in the plurality of users; and then determine the transition probability between the two pieces of device information in the device information pair based on a ratio of the quantity of users that meet the target condition to a quantity of the plurality of users. For example, for the device information pair <device information 1, device information 2>, if the quantity of users that meet the target condition in the plurality of users is K, and the quantity of the plurality of users is M, a transition probability between the two pieces of device information in the device information pair can be

$$\frac{K}{M} * 100 \% .$$

In the technical solution in the above-mentioned embodiment, a transition probability between two pieces of device information is calculated based on the ratio of the quantity of users that meet the target condition to the quantity of the plurality of users. In this way, accuracy of the transition probability can be ensured. In addition, an implementation is simple, and time costs required for constructing the transition probability table can be lowered.

After determining the transition probability corresponding to each of the plurality of device information pairs, the server 130 can generate the transition probability table based on the transition probability corresponding to each of the plurality of device information pairs.

In some embodiments, the transition probability table can be further regularly or irregularly updated. For example, when a new user triggers a service request or an old user triggers a service request again, a device information pair and a transition probability corresponding to the device information pair in the transition probability table can be updated. For example, a new device information pair and a corresponding transition probability are added to the transition probability table.

Manner 2: The transition probability between each of the N pieces of second device information and the first device information is determined by using a probability prediction model.

The server 130 can obtain a pre-trained probability prediction model. The probability prediction model can be a trained machine learning model. A model structure of the probability prediction model is not limited in this specification. The probability prediction model is trained to predict a transition probability between two different pieces of device information. For example, the probability prediction model can include two inputs respectively corresponding to two pieces of device information. The probability prediction model can predict a transition probability between device information corresponding to a first input and device information corresponding to a second input.

For each of the N pieces of second device information, the server 130 can input the second device information and the first device information into the probability prediction model. The second device information is used as the first input to the probability prediction model, and the first device information is used as the second input to the probability prediction model. The probability prediction model outputs the transition probability between the second device information and the first device information.

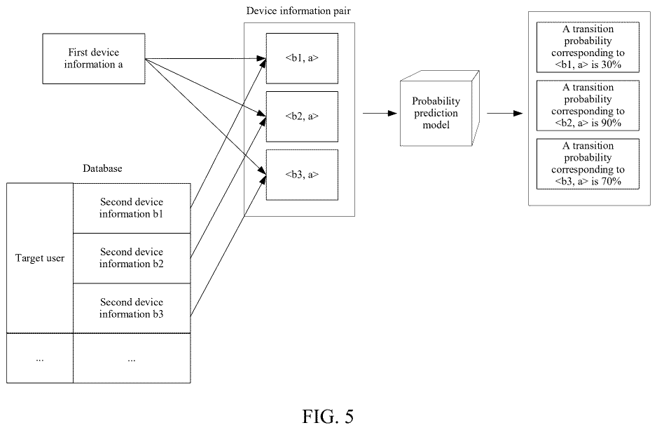

For ease of understanding, how the server 130 determines the transition probability between each of the N pieces of second device information and the first device information based on the probability prediction model is described below in detail with reference to FIG. 5.

FIG. 5 is a schematic diagram of another manner of determining a transition probability according to an embodiment of this specification. As shown in FIG. 5, the server 130 can obtain first device information a and three pieces of second device information b1, b2, and b3. For the obtaining process, refer to the related descriptions in FIG. 4. Details are not described herein again.

Still referring to FIG. 5, the server 130 uses the second device information b1 as the first input to the probability prediction model, and uses the first device information a as the second input to the probability prediction model, so that the probability prediction model obtains a corresponding transition probability based on the second device information b1 and the first device information a; the server 130 uses the second device information b2 as the first input to the probability prediction model, and uses the first device information a as the second input to the probability prediction model, so that the probability prediction model obtains a corresponding transition probability based on the second device information b2 and the first device information a; and the server 130 uses the second device information b3 as the first input to the probability prediction model, and uses the first device information a as the second input to the probability prediction model, so that the probability prediction model obtains a corresponding transition probability based on the second device information b3 and the first device information a.

In the technical solution in the above-mentioned embodiment, the server 130 can input the first device information and the second device information into the machine learning model (that is, the probability prediction model), to obtain the transition probability between the second device information and the first device information. An excellent data processing capability of the machine learning model enables the server 130 to obtain the transition probability more quickly and efficiently. The machine learning model can continuously learn from new data through online learning or incremental learning, to maintain accuracy and timeliness of the transition probability.

The following describes a training process of the probability prediction model. It should be noted that the training process of the probability prediction model can be performed by the server 130, or can be performed by another device. This is not limited in this specification. The following uses an example in which the server 130 performs the training process as an example for description.

The server 130 can obtain a plurality of training samples. Each training sample includes first sample device information, second sample device information, and a labeled transition probability between the first sample device information and the second sample device information. A person skilled in the art can understand that for meanings and content of the first sample device information and the second sample device information, refer to the above-mentioned descriptions of the first device information and the second device information. Details are not described herein again.

For example, the labeled transition probability between the first sample device information and the second sample device information can be obtained through manual labeling. For another example, the labeled transition probability can be obtained by performing statistical analysis on a large amount of device collection data.

The probability prediction model can be a deep learning model suitable for processing sequence data. In some embodiments, the probability prediction model can be a model of a similar structure, for example, a recurrent neural network (RNN) or a long short-term memory (LSTM) network.

The server 130 randomly initializes a model parameter of the probability prediction model. Further, the server 130 performs a plurality of rounds of iterative training on the probability prediction model based on the plurality of training samples. A process of each round of iterative training can include: inputting the first sample device information and the second sample device information into the probability prediction model, and obtaining a predicted transition probability output by the probability prediction model; and updating a parameter of the probability prediction model with an objective of minimizing a difference between the predicted transition probability and the labeled transition probability.

For example, a target loss function is used to represent the difference between the predicted transition probability and the labeled transition probability. It should be noted that a type of the target loss function is not limited in this specification. For example, both a mean squared error (MSE) and a cross-entropy loss can be used as the target loss function. The server 130 can update the model parameter of the probability prediction model with an objective of minimizing the target loss function and by using a backpropagation algorithm and an optimizer (for example, Adam or SGD).

The server 130 can repeat the iterative training process until a trained probability prediction model is obtained when a preset training end condition is met. The training end condition can include but is not limited to that the probability prediction model converges, a preset training round is reached, and so on.

In the technical solution in the above-mentioned embodiment, the probability prediction model is trained by using a plurality of pieces of sample device information and a labeled transition probability between different sample device information, so that the trained probability prediction model has a capability of predicting a transition probability between different device information.

S330: Identify, based on the transition probability between each of the N pieces of second device information and the first device information, whether the target terminal device is the historical terminal device previously used by the target user.

In some embodiments, the server 130 can determine, based on a result of comparison between the transition probability between each of the N pieces of second device information and the first device information and a target threshold, whether the target terminal device is the historical terminal device previously used by the target user.

For example, if a transition probability between at least one of the N pieces of second device information and the first device information is greater than or equal to the target threshold, there is a relatively high possibility that there is transition of the historical terminal device to the target terminal device, and then it is determined that the target terminal device is the historical terminal device previously used by the target user.

For another example, if transition probabilities between all of the N pieces of second device information and the first device information are all less than the target threshold, there is a relatively low possibility that there is transition of the historical terminal device to the target terminal device, and then it is determined that the target terminal device is not the historical terminal device previously used by the target user.

The target threshold can be formulated based on a specific use scenario of the terminal device. This is not limited herein.

In some embodiments, after obtaining the transition probability between each of the N pieces of second device information and the first device information, the server 130 can first determine a highest transition probability in N transition probabilities, and determine, based on a result of comparison between the highest transition probability and the target threshold, whether the target terminal device is the historical terminal device previously used by the user.

For example, if the highest transition probability is greater than or equal to the target threshold, it indicates that it is highly probable that the first device information is obtained by transforming second device information corresponding to the highest transition probability, and then it is determined that the target terminal device is the historical terminal device previously used by the target user.

For another example, if the highest transition probability is less than the target threshold, it indicates that it is not likely that the first device information is obtained by transforming second device information corresponding to the highest transition probability, and then it is determined that the target terminal device is not the historical terminal device previously used by the target user.

In the technical solution in the above-mentioned embodiment, the server 130 determines, by comparing the transition probability with the target threshold, whether the target terminal device is the historical terminal device previously used by the target user, to easily and quickly obtain a device identification result.

In some embodiments, the server 130 can further determine, based on the identification result, whether to perform identity verification on a current user of the target terminal device.

For example, if the identification result indicates that the target terminal device is the historical terminal device previously used by the target user, the server 130 considers that the current user of the target terminal device is the target user (a valid user/registered user). In this case, the server 130 considers that identity verification may not be performed on the current user. Therefore, the server 130 indicates the target terminal device to skip an identity verification procedure and directly provide a target service to the current user. For example, if the current user initiates a payment request, the target terminal device no longer displays an identity verification instruction about the user in an interaction interface of the target terminal device based on the indication, that is, the user can complete a payment without entering verification information such as a fingerprint or a verification code.

If the identification result indicates that the target terminal device is not the historical terminal device previously used by the target user, the server 130 considers that the current user of the target terminal device may not be the target user (a valid user/registered user). In this case, the server 130 determines to perform identity verification on the current user. Therefore, the server 130 indicates the target terminal device to perform identity verification on the current user and then provide a target service. In this way, service security can be ensured. After receiving the identity verification indication, the target terminal device can verify an identity of the user through biometric identity verification, by using a verification code, or in another manner. For example, in an interaction interface of the target terminal device, the user is indicated to enter a fingerprint or a verification code, or the user is indicated to perform facial recognition. For example, if the current user initiates a payment request, the current user completes a related operation based on the indication in the interaction interface. If the identity verification succeeds, the payment succeeds. If the identity verification fails, the payment fails.

In the technical solution in the above-mentioned embodiment, when the server 130 identifies that the target terminal device is the historical terminal device previously used by the target user, no identity verification procedure needs to be performed on the current user. The current user can complete the service request more quickly, and there is no need to perform identity verification, to avoid causing relatively much disturbance to the current user.

In some embodiments, each time device identification needs to be performed, the server 130 can perform device identification based on a transition probability between different device information (that is, S320-S330 described above).

In some embodiments, after obtaining the first device information corresponding to the target terminal device and obtaining the N pieces of second device information associated with the target user, the server 130 can first match the first device information with each of the N pieces of second device information. A meaning of matching herein can be understood as determining whether the first device information is consistent with the second device information. If the first device information successfully matches at least one of the N pieces of second device information, it indicates that the target terminal device is the historical terminal device previously used by the target user. In this case, the server 130 does not need to perform device identification based on the transition probability between different device information, that is, does not need to perform S320-S330, thereby reducing a specific calculation amount. If the first device information fails to match each of the N pieces of second device information, the server 130 determines that device identification needs to be performed based on the transition probability between different device information. In this case, the server 130 performs S320-S330.

In the technical solution in the above-mentioned embodiment, after obtaining the first device information and the N pieces of second device information, the server 130 first matches the first device information with each of the N pieces of second device information. If the first device information successfully matches at least one of the N pieces of second device information, there is no need to perform subsequent determining, thereby reducing a waste of computing resources of the server 130.

In conclusion, according to the device identification method and system, and the storage medium provided in this specification, it can be identified whether the target terminal device is the historical terminal device previously used by the target user. During identification, the server performs processing no longer based on a result of comparison between device fingerprints but based on the transition probability between each of the N pieces of second device information (that is, the device information corresponding to the historical terminal device) and the first device information (that is, the device information corresponding to the target terminal device). In the above-mentioned identification process, a transformation possibility of the device information of the terminal device is considered. This is more consistent with an actual use status of the terminal device. Therefore, when it is identified whether the target terminal device is the historical terminal device, an identification result is more accurate, and a case of incorrect determining caused by a change in device information of a same terminal device can be avoided.

According to another aspect of this specification, a non-transitory storage medium is provided, and stores at least one group of executable instructions for performing device identification. When the executable instructions are executed by a processor, the executable instructions instruct the processor to implement the steps in the method P300 described in this specification. In some possible implementations, various aspects of this specification can be further implemented in a form of a program product, including program code. When the program product runs on the computing device 200, the program code is used to enable the computing device 200 to perform the steps in the method P300 described in this specification. The program product configured to implement the above-mentioned method can use a portable compact disc read-only memory (CD-ROM) that includes program code, and can run on the computing device 200. However, the program product in this specification is not limited thereto. In this specification, a readable storage medium can be any tangible medium that includes or stores a program, and the program can be used by or in combination with an instruction execution system. The program product can be any combination of one or more readable media. The readable medium can be a readable signal medium or a readable storage medium. For example, the readable storage medium can be but is not limited to an electrical system, apparatus, or device, a magnetic system, apparatus, or device, an optical system, apparatus, or device, an electromagnetic system, apparatus, or device, an infrared system, apparatus, or device, or a semiconductor system, apparatus, or device, or any combination thereof. More specific examples of the readable storage medium include an electrical connection including one or more conducting wires, a portable disk, a hard disk, a random access memory (RAM), a read-only memory (ROM), an erasable programmable read-only memory (EPROM) or a flash memory, an optical fiber, a portable compact disc read-only memory (CD-ROM), an optical storage device, a magnetic storage device, or any proper combination thereof. The computer-readable storage medium can include a data signal propagated in a baseband or as a part of a carrier, and carries readable program code. The propagated data signal can be in a plurality of forms, and includes but is not limited to an electromagnetic signal, an optical signal, or any proper combination thereof. The readable storage medium can alternatively be any readable medium other than the readable storage medium, and the readable medium can send, propagate, or transmit a program used by or in combination with an instruction execution system, apparatus, or device. The program code included in the readable storage medium can be transmitted by using any proper medium, including but not limited to a wireless medium, a wired medium, an optical cable, an RF medium, or any proper combination thereof. Program code for performing the operations in this specification can be written by using any combination of one or more program design languages. The program design language includes an object-oriented program design language, for example, Java or C++, and further includes a conventional procedural program design language, for example, “C” language, or a similar program design language. The program code can be completely executed on the computing device 200, partially executed on the computing device 200, executed as an independent software package, partially executed on the computing device 200 and partially executed on a remote computing device, or completely executed on a remote computing device.

In the technical solutions provided in this specification, collection and use of the related device information of the device comply with related laws and regulations, and do not violate public order and good morals.

Specific embodiments of this specification are described above. Other embodiments fall within the scope of the appended claims. In some cases, the actions or steps described in the claims can be performed in an order different from that in the embodiments and desired results can still be achieved. In addition, the process depicted in the accompanying drawings does not necessarily need a particular order or consecutive order to achieve the desired results. In some implementations, multitasking and parallel processing are possible or may be advantageous.

In conclusion, after reading the detailed disclosure, a person skilled in the art can understand that the detailed disclosure can be presented only by using an example, and can impose no limitation. Although it is not explicitly stated herein, a person skilled in the art can understand that the requirements of this specification include various proper changes, improvements, and modifications to the embodiments. These changes, improvements, and modifications are intended to be provided in this specification, and fall within the spirit and scope of the example embodiments of this specification.

In addition, some terms in this specification are used to describe the embodiments of this specification. For example, “one embodiment”, “embodiments”, and/or “some embodiments” mean/means that specific features, structures, or characteristics described with reference to the embodiment can be included in at least one embodiment of this specification. Therefore, it can be emphasized and understood that two or more references to “embodiments”, “one embodiment”, or “alternative embodiments” in various parts of this specification do not necessarily refer to a same embodiment. In addition, specific features, structures, or characteristics can be properly combined in one or more embodiments of this specification.

It should be understood that in the above-mentioned descriptions of the embodiments of this specification, to help understand a feature, for the purpose of simplifying this specification, various features are combined in a single embodiment, accompanying drawing, or description thereof in this specification. However, this does not mean that the combination of these features is necessary. It is entirely possible for a person skilled in the art to mark some devices and understand the devices as separate embodiments when reading this specification. That is, the embodiments of this specification can also be understood as an integration of a plurality of secondary embodiments. Content of each secondary embodiment is also true when a quantity of features is less than a quantity of all features in one of the above disclosed embodiments.

Each patent, patent application, publication of a patent application, and other materials, for example, articles, books, instructions, publications, documents, and products, that are cited in this specification and that are other than any document that is inconsistent or conflict with this document or that imposes limiting impact on the widest scope of the claims can be incorporated herein by reference and used for all purposes now or later associated with this document. In addition, the terms in this document shall prevail if there is any inconsistency or conflict between the descriptions, definitions, and/or use of the related terms in any material and the descriptions, definitions, and/or use of the related terms in this document.

Finally, it should be understood that the principles of the implementation solutions of this specification are described in the implementation solutions of the application disclosed in this specification. Other modified embodiments also fall within the scope of this specification. Therefore, the embodiments disclosed in this specification are merely examples and not limitations. A person skilled in the art can use an alternative configuration according to the embodiments of this specification to implement the application in this specification. Therefore, the embodiments of this specification are not limited to the embodiments accurately described in the application.

1. A device identification method, comprising:
obtaining first device information corresponding to a target terminal device, and obtaining N pieces of second device information associated with a target user, wherein the second device information is device information of a historical terminal device previously used by the target user, and N is an integer greater than or equal to 1;
determining a transition probability between each of the N pieces of second device information and the first device information, wherein the transition probability represents a possibility that device information of a same terminal device is transformed from the second device information to the first device information; and
identifying, based on the transition probability between each of the N pieces of second device information and the first device information, whether the target terminal device is the historical terminal device previously used by the target user.

2. The method according to claim 1, wherein the first device information comprises K information items, the K information items are used to describe at least one of an intrinsic attribute and a weakly variable attribute of the target terminal device, and K is an integer less than or equal to a preset value; and
the second device information comprises a same information item as the first device information.

3. The method according to claim 2, wherein the K information items comprise at least one of the following:
a device model, operating system information, processor information, a memory capacity, a device development board model, an operator type, and screen resolution.

4. The method according to claim 1, wherein the determining a transition probability between each of the N pieces of second device information and the first device information comprises:
obtaining a pre-constructed transition probability table, wherein the transition probability table indicates a transition probability between different device information; and
for each of the N pieces of second device information, querying the transition probability table based on the second device information and the first device information, to obtain the transition probability between the second device information and the first device information.

5. The method according to claim 4, wherein the transition probability table is constructed in the following manner:
obtaining device collection data of a plurality of users, wherein the device collection data of each user comprises a plurality of pieces of device information obtained by performing a plurality of times of information collection on a terminal device of the user;
combining different device information in the device collection data of the plurality of users to generate a plurality of device information pairs, wherein each device information pair comprises two pieces of device information arranged in an order;
for each device information pair, determining a transition probability between the two pieces of device information in the device information pair based on distribution of the two pieces of device information in the device information pair in the device collection data of the plurality of users; and
generating the transition probability table based on the transition probability corresponding to each of the plurality of device information pairs.

6. The method according to claim 5, wherein the determining a transition probability between the two pieces of device information in the device information pair based on distribution of the two pieces of device information in the device information pair in the device collection data of the plurality of users comprises:
determining a quantity of users that meet a target condition in the plurality of users, wherein the target condition comprises that the device collection data comprises the two pieces of device information in the device information pair, and an order of the two pieces of device information in the device collection data is the same as an order of the two pieces of device information in the device information pair; and
determining the transition probability between the two pieces of device information in the device information pair based on a ratio of the quantity of users that meet the target condition to a quantity of the plurality of users.

7. The method according to claim 1, wherein the determining a transition probability between each of the N pieces of second device information and the first device information comprises:
obtaining a pre-trained probability prediction model, wherein the probability prediction model is trained to predict a transition probability between two different pieces of device information; and
for each of the N pieces of second device information, inputting the second device information and the first device information into the probability prediction model, to obtain the transition probability between the second device information and the first device information.

8. The method according to claim 7, wherein the probability prediction model is obtained through training in the following manner:
obtaining a plurality of training samples, wherein each training sample comprises first sample device information, second sample device information, and a labeled transition probability between the first sample device information and the second sample device information;
inputting the first sample device information and the second sample device information into the probability prediction model, and obtaining a predicted transition probability output by the probability prediction model; and
updating a parameter of the probability prediction model with an objective of minimizing a difference between the predicted transition probability and the labeled transition probability.

9. The method according to claim 1, wherein the identifying, based on the transition probability between each of the N pieces of second device information and the first device information, whether the target terminal device is the historical terminal device previously used by the target user comprises:
if a transition probability between at least one of the N pieces of second device information and the first device information is greater than or equal to a target threshold, determining that the target terminal device is the historical terminal device previously used by the target user; or
if transition probabilities between all of the N pieces of second device information and the first device information are all less than the target threshold, determining that the target terminal device is not the historical terminal device previously used by the target user.

10. The method according to claim 1, wherein the determining a transition probability between each of the N pieces of second device information and the first device information comprises:
matching the first device information with each of the N pieces of second device information, and if the first device information fails to match each of the N pieces of second device information, determining the transition probability between each of the N pieces of second device information and the first device information.

11-19. (canceled)

20. A non-transitory computer-readable storage medium, wherein the non-transitory computer-readable storage medium stores a computer program, which when executed by a processor causes the processor to:
obtain first device information corresponding to a target terminal device, and obtain N pieces of second device information associated with a target user, wherein the second device information is device information of a historical terminal device previously used by the target user, and N is an integer greater than or equal to 1;
determine a transition probability between each of the N pieces of second device information and the first device information, wherein the transition probability represents a possibility that device information of a same terminal device is transformed from the second device information to the first device information; and
identify, based on the transition probability between each of the N pieces of second device information and the first device information, whether the target terminal device is the historical terminal device previously used by the target user.

21. The non-transitory computer-readable storage medium according to claim 20, wherein the first device information comprises K information items, the K information items are used to describe at least one of an intrinsic attribute and a weakly variable attribute of the target terminal device, and K is an integer less than or equal to a preset value; and
the second device information comprises a same information item as the first device information.

22. The non-transitory computer-readable storage medium according to claim 21, wherein the K information items comprise at least one of the following:
a device model, operating system information, processor information, a memory capacity, a device development board model, an operator type, and screen resolution.

23. The non-transitory computer-readable storage medium according to claim 20, wherein the processor being caused to determine a transition probability between each of the N pieces of second device information and the first device information comprises being caused to:
obtain a pre-constructed transition probability table, wherein the transition probability table indicates a transition probability between different device information; and
for each of the N pieces of second device information, query the transition probability table based on the second device information and the first device information, to obtain the transition probability between the second device information and the first device information.

24. The non-transitory computer-readable storage medium according to claim 23, wherein the transition probability table is constructed in the following manner:
obtaining device collection data of a plurality of users, wherein the device collection data of each user comprises a plurality of pieces of device information obtained by performing a plurality of times of information collection on a terminal device of the user;
combining different device information in the device collection data of the plurality of users to generate a plurality of device information pairs, wherein each device information pair comprises two pieces of device information arranged in an order;
for each device information pair, determining a transition probability between the two pieces of device information in the device information pair based on distribution of the two pieces of device information in the device information pair in the device collection data of the plurality of users; and
generating the transition probability table based on the transition probability corresponding to each of the plurality of device information pairs.

25. A computing device, comprising a memory and a processor, wherein the memory stores executable code, and when the processor executes the executable code, the computing device is caused to:
obtain first device information corresponding to a target terminal device, and obtain N pieces of second device information associated with a target user, wherein the second device information is device information of a historical terminal device previously used by the target user, and N is an integer greater than or equal to 1;
determine a transition probability between each of the N pieces of second device information and the first device information, wherein the transition probability represents a possibility that device information of a same terminal device is transformed from the second device information to the first device information; and
identify, based on the transition probability between each of the N pieces of second device information and the first device information, whether the target terminal device is the historical terminal device previously used by the target user.

26. The computing device according to claim 25, wherein the first device information comprises K information items, the K information items are used to describe at least one of an intrinsic attribute and a weakly variable attribute of the target terminal device, and K is an integer less than or equal to a preset value; and
the second device information comprises a same information item as the first device information.

27. The computing device according to claim 26, wherein the K information items comprise at least one of the following:
a device model, operating system information, processor information, a memory capacity, a device development board model, an operator type, and screen resolution.

28. The computing device according to claim 25, wherein the computing device being caused to determine a transition probability between each of the N pieces of second device information and the first device information comprises being caused to:
obtain a pre-constructed transition probability table, wherein the transition probability table indicates a transition probability between different device information; and
for each of the N pieces of second device information, query the transition probability table based on the second device information and the first device information, to obtain the transition probability between the second device information and the first device information.

29. The computing device according to claim 28, wherein the transition probability table is constructed in the following manner:
obtaining device collection data of a plurality of users, wherein the device collection data of each user comprises a plurality of pieces of device information obtained by performing a plurality of times of information collection on a terminal device of the user;
combining different device information in the device collection data of the plurality of users to generate a plurality of device information pairs, wherein each device information pair comprises two pieces of device information arranged in an order;
for each device information pair, determining a transition probability between the two pieces of device information in the device information pair based on distribution of the two pieces of device information in the device information pair in the device collection data of the plurality of users; and
generating the transition probability table based on the transition probability corresponding to each of the plurality of device information pairs.
